(19) United States
(12) Patent Application Publication
(10) Pub. No.: US 2003/0019113 A1
(43) Pub. Date: Jan. 30, 2003

(54) Steering column module with steering angle sensor having low sensitivity to steering column radial run-out

(75) Inventors: Peter Kofink, Ingersheim (DE); Christian Reutz, Ludwigsburg (DE)

Correspondence Address: Dreiss, Fuhlendorf, Steimle & Becker, Postfach 10 37 62, Stuttgart, D-70032, DE

(73) Assignee: VALEO Schalter und Sensoren GmbH, Bietigheim-Bissingen (DE)

(21) Appl. No.: 09/912,477

(22) Filed: Jul. 26, 2001

(51) Int. Cl. G01B 3/56

(52) U.S. Cl. 33/1 PT; 33/534

(57) ABSTRACT

A steering column module is proposed comprising a steering angle sensor, wherein the code disc (27) of the steering angle sensor (3) is disposed therein such that the space which can be used for a signal transmission case (1) is enlarged. The steering angle measurement is insensitive to inaccuracies in the steering column (5) and the steering wheel. The steering angle sensor can furthermore be mounted and its function can be checked outside of the vehicle.

This application is related to DE 199 33 049 filed Jul. 15, 1999 the entire disclosure of which is hereby incorporated by reference

### BACKGROUND OF THE INVENTION

The invention concerns a steering column module for motor vehicles comprising a signal transmission case, wherein the signal transmission case comprises a part which can rotate with a steering wheel of the motor vehicle, and a steering angle sensor, wherein the steering angle sensor comprises a rotatable code disc.

In one conventional steering column module, a code disc on which the angle information is stored in the form of code teeth is a component of the rotatable part of the signal transmission case.

The rotatable part of the signal transmission case of this arrangement is disadvantageously coupled to the steering wheel of the motor vehicle thereby transmitting all manufacturing or assembly tolerances in the axial and radial direction of the steering column and steering wheel to the code disc. The steering angles to be measured must be determined very exactly, and therefore, the admissible tolerances with respect to code disc and scanning means of the steering angle sensor are very close. The above-mentioned tolerances of steering column and steering wheel can cause a considerable measurement error for the steering angle sensor or even damage the code disc or scanning means if these components come into contact. Moreover, the steering column module only functions when installed in the motor vehicle since the rotatable part of the signal transmission case and therefore also the code disc are held by the steering wheel.

It is therefore the underlying purpose of the present invention to provide a steering column module wherein the measurement of the steering angle is insensitive to the production inaccuracies of steering column and steering wheel of the motor vehicle. The steering column module should also function outside of a motor vehicle.

### SUMMARY OF THE INVENTION

This object is achieved in accordance with the invention by a steering column module for motor vehicles having a signal transmission case, wherein the signal transmission case comprises a part which can rotate with the steering wheel of the motor vehicle, and a steering angle sensor, wherein the steering angle sensor comprises a rotatable code disc and wherein the code disc is disposed in the steering angle sensor. In this manner, the relative position of the scanning device of the steering angle sensor and the code disc are fixed with respect to one another with small tolerances and the measurement error of the steering angle sensor is consequently small. The complete steering column module can be mounted and its function tested outside of the motor vehicle. Displacement of the code disc from the signal transmission case to the steering angle sensor produces more space for one or two broad-band cables—with identical outer dimensions—which transmit the signals and electric currents from the steering wheel to the motor vehicle and vice versa. This is important, in particular for modern vehicles since more and more functions are performed from the steering wheel.

In an embodiment of the invention, the code disc is connected for secure rotation with the rotatable part of the signal transmission case. This embodiment has the advantage that the steering motion is still transmitted via the signal transmission case, however, inaccuracies in the steering column, the steering wheel and/or the signal transmission case have only little effect on the measurement of the steering angle since the code disc, viewed in the direction of the longitudinal axis of the steering column, is disposed closer to the pivot of the steering column in the tubular shell.

In one variant, the code disc or the rotatable part of the signal transmission case has at least one axially extending projection which engages a radially extending opening in the rotatable part of the signal transmission case or of the code disc, wherein the side walls of the recess can advantageously absorb tangential forces exerted by or on the projection or transfer them to the pin. Since the recess extends in the radial direction, there is no radial transmission of forces between the recess and the projection. The same is true for the axial direction since the pin can move freely in this direction, in particular if the opening is a through-opening.

In another embodiment, the projection(s) is/are pins which are disposed eccentrically and extend in the axial direction with the opening being a slot extending in the radial direction such that play-free transmission of forces in the tangential but not in the radial direction is effected in a simple and inexpensive fashion.

A further variant provides that the code disc is radially secured and rotatably disposed in a carrier of the steering angle sensor such that code disc and steering angle sensor can be produced as an assembled unit and the relative position of the two components with respect to one another will not be changed.

In accordance with an advantageous embodiment of the invention, the code disc is radially secured and rotatably disposed in a casing of the steering angle sensor such that the code disc is easy to mount by connecting the casing with the steering angle sensor.

In a further embodiment of the invention, the code disc is disposed in a bearing ring and a bearing piece to guarantee precise bearing.

In accordance with a further advantageous embodiment of the invention, the carrier of the steering angle sensor is provided with a scanning device for scanning the code disc to further improve the accuracy of the relative position of the code disc and scanning device.

In an enhancement of the invention, the turning angle encoding is disposed on an end face of the code disc to render the steering angle sensor particularly compact.

In another variant, the turning angle encoding is provided on the code disc in the form of holes. This type of turning angle encoding is particularly robust, easy to produce and insensitive to external influences, such as e.g. soiling.

Another variant provides that the turning angle encoding is disposed on a tubular shell of the code disc such that the scanning device can be disposed substantially outside of the code disc.

In a further embodiment of the invention at least one steering column switch is disposed on the steering column module to permit the steering column module to assume further functions.

In a further embodiment the signal transmission case, the steering angle sensor and/or second and third steering column switch can be connected with a first steering column switch into a steering column module to facilitate construction and permit inexpensive assembly of the steering column module.

One variant provides that a first evaluation electronics of the steering angle sensor and a second evaluation electronics of the signal transmission case and/or the steering column switch(es) are disposed close to one another to reduce the space required for the first and second evaluation electronics. This is true in particular for the part of the steering column module facing away from the steering wheel.

In another variant the first steering column switch actuates the blinker and comprises a blinker returning position, wherein the blinker returning position can be controlled by the steering angle sensor. In this manner, the steering column module can function prior to installation in the vehicle and that function can be checked before assembly.

Further advantages and advantageous embodiments of the invention can be extracted from the following description, the drawing and the claims.

One embodiment of the subject matter of the invention is shown in the drawing and explained in more detail below.

### BRIEF DESCRIPTION OF THE DRAWING

FIG. 1 shows an exploded view of the inventive steering column module;

FIG. 2 shows an exploded view of an embodiment of an inventive steering angle sensor;

FIG. 3 shows an exploded view of a further embodiment of an inventive steering angle sensor;

FIG. 4 shows an exploded view of the cooperation between steering angle sensor and signal transmission case; and

FIG. 5 shows an exploded view of the cooperation between steering angle sensor and steering column switch.

### DESCRIPTION OF THE PREFERRED EMBODIMENT

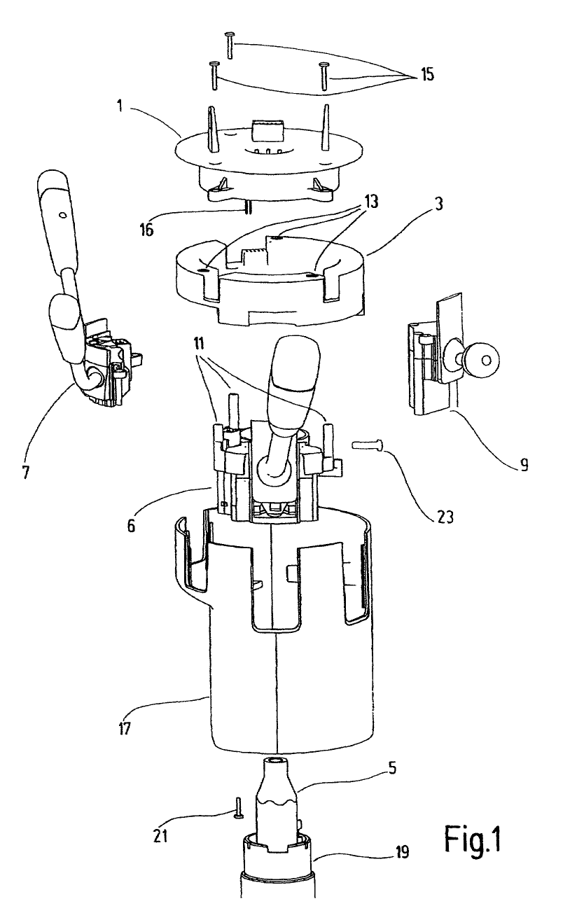

FIG. 1 shows an exploded view of an inventive steering column module. A signal transmission case 1 serves for transmitting electrical signals from a steering wheel (not shown) to a steering column module and from there into the dashboard system of the vehicle. The signal transmission case 1 comprises i.e. one part which is fixed with respect to the steering column module, and one part which rotates with the steering wheel. The signal transmission case 1 contains a broad-band cable (not shown) which is shaped e.g. as a flat spiraled spring. This broad-band cable transmits information or electric currents from the steering wheel to the vehicle and vice versa. In modern vehicles, i.e. the horn, an airbag and the shifting of gears can all be actuated from the steering wheel.

A steering angle sensor 3 is provided below the signal transmission case 1. The steering angle sensor 3 determines, e.g. through optical scanning of a code disc (not shown), the steering angle of a steering column 5 and thereby the position of the steered wheels. The steering angle data can be encoded by a first evaluation electronics (not shown) into low or high-speed-CAN-bus data and transmitted to the vehicle where they can be used e.g. as input variable for a vehicle travel stabilization program.

A first steering column switch 6 serves e.g. for actuating the turn indicator, the light and the windscreen wipers. The first steering column switch 6 also bears the steering column module, in that the other components of the steering column module are connected thereto. Towards this end a second steering column switch 7 and a third steering column switch 9 are placed from the top over guides 11, designed as cylindrical pins. The steering angle sensor 3 is then pushed over the guides 11 via steering angle sensor 3 bores 13, whose diameter and separation match the guides 11. Finally, the signal transmission case 1 is located and the steering column module is fixed by screwing three screws 15 into threads (not shown) in the guides 11. The three screws 15 pass through corresponding bores in the signal transmission case 1 and the steering angle sensor 3.

A cover 17 protects the steering column module from external influences such as e.g. dust, provides the steering column module with a pleasant exterior/appearance, and also covers the steering column 5 and a tubular shell 19. The cover 17 is placed over the steering column module from below and is screwed to the steering column module using one or more screws 21. Since the steering column 5 is disposed in the tubular shell 19, concentricity tolerances in the steering column and/or the eccentricity of the steering column 5 with respect to the tubular shell 19 increase with increasing separation between the steering column 5 and the tubular shell 19.

The second and third steering column switch 7 and 9 can be used e.g. for controlling the vehicle speed and for special functions.

Mounting of the steering angle sensor 3 onto the guides 11 produces automatic contact of three plugs (not shown), between the steering angle sensor 3 and the corresponding plugs of the first, second and third steering column switches 6,7 and 9. Mounting of the signal transmission case 1 onto the guides 11 automatically produces contact between a plug (not shown) of the signal transmission case 1 and a corresponding plug of the steering angle sensor 3.

A second evaluation electronics (not separately shown) is disposed close to the first evaluation electronics and receives or transmits signals via the contacts between the steering angle sensor 3 and the module components: namely the signal transmission case 1, the first, the second and the third steering column switches 6,7 and 8. These signals are encoded or decoded by the second evaluation electronics into low- or high-speed-CAN-bus data and transmitted to or received by the vehicle. The signals transmitted or received by the first evaluation electronics and the signals transmitted or received by the second evaluation electronics are advantageously transmitted or received via an interface between the steering column module and vehicle.

A pin 16 projects in the axial direction past the signal transmission case 1, is connected to the rotary part of the signal transmission case 1, and engages in the code disc of the steering angle sensor 3 (not shown in FIG. 1). The pin 16 also represents the restoring cam for the turn indicator function of the first steering column switch 6.

The steering column module is detachably mounted in the vehicle. Towards this end, the steering column module is placed from the top over the tubular shell 19 of the vehicle and mounted to the tubular shell 19, via a mounting bracket disposed on the first steering column switch 6, with a screw 23.

Mounting of the steering column module in the vehicle automatically produces contact between the plug (not shown in FIG. 1) of the steering column module and the corresponding plug of the vehicle (also not shown in FIG. 1). This plug represents the above-mentioned interface between steering column module and vehicle.

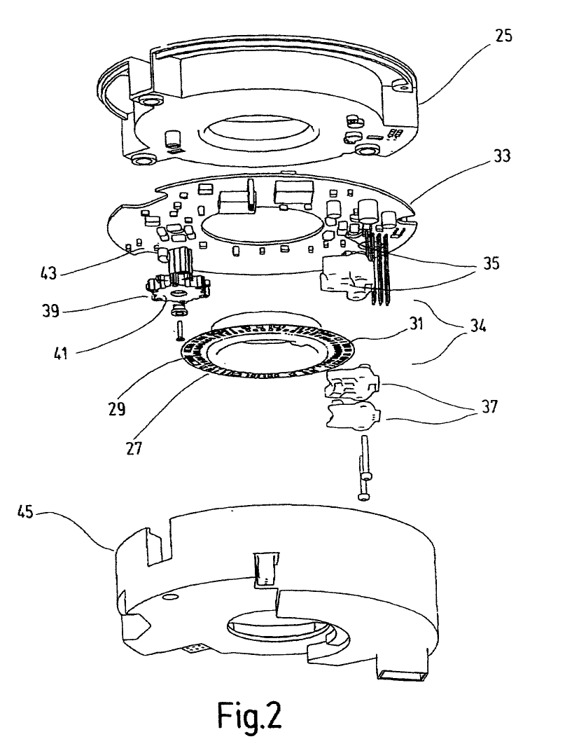

FIG. 2 shows an exploded view of the steering angle sensor 3. A code disc 27 which is rotatably mounted in the carrier 25 of the steering angle sensor 3 comprises an incremental track 29 and a code track 31. The code disc 27 is e.g. a perforated disc.

In the mounted state, the pin 16 shown in FIG. 1 engages a recess of the code disc 27 and thereby transmits the steering motion of the steering wheel to the code disc 27. The recess can be a slot extending in the radial direction which transfers the rotary motion of the pin 16 in the tangential direction without play and which compensates in the radial direction for concentricity errors of the steering column 5, of the signal transmission case 1 or of the steering wheel. As viewed in the direction of the longitudinal axis of the steering column, the code disc is disposed proximate to the bearing of the steering column in the tubular shell. This additionally improves the accuracy of the rotary angle measurement.

A printed circuit board 33 of the steering angle sensor 3 is provided with a scanning device 34 which consists substantially of a transmitter 35 with e.g. 4 light diodes and a receiver 37 with e.g. 4 transistors. In the assembled state, the transmitter 35 emits light through the holes of the code disc 27 to the receiver 37. The arrangement of the holes in the incremental track 29 and the code track 31 of the code disc 27 determine the steering angle throughout a steering wheel rotational range of 360° C.

A revolution recognition means 39 determines the number of steering wheel revolutions. A toothed wheel 41 provided with a magnet is thereby carried along once per rotation by the code disc 27. 6 Hall elements 43 are provided below the toothed wheel 41, one of which is always switched. 6 Hall elements can thereby uniquely determine six steering wheel rotations. The first and second evaluation electronics are both located on the printed circuit board 33. Since the first and second evaluation electronics are shown without visible spatial separation, separate reference numerals have been omitted.

A casing 45 protects the steering angle sensor 3 from external influences.

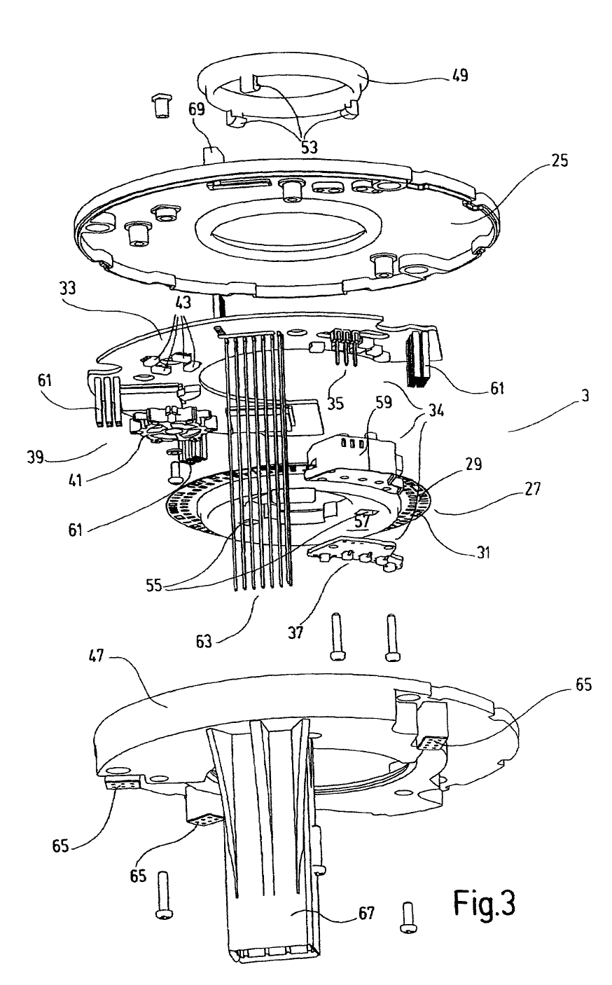

FIG. 3 shows a further embodiment of an inventive steering angle sensor 3 in an exploded view. Corresponding features can be gathered from FIGS. 1 and 2 and their descriptions.

The code disc 27 is rotatably disposed in a casing 47 of the steering angle sensor 3. The mounting consists of a bearing ring 49 and a corresponding bore 51 in the casing 47. The bearing ring comprises three hook-shaped projections 53 which detachably or non-detachably lock in corresponding recesses 55 of the code disc 27 or of a bearing piece 57 when assembled.

The printed circuit board 33 is shown to have a scanning means 34 which consists substantially of a transmitter 35 with e.g. 5 light diodes and a receiver 37 with e.g. 5 transistors. A cover 59 is disposed between transmitter 35 and receiver 37 which keeps stray light away from the scanning means 34 and which bears the transmitter 35.

The revolution recognition means 39 comprises 4 Hall elements 43 one of which is always switched. The printed circuit board 33 is furthermore provided with plug pins 61 and 63. The plug pins 61 contact the first, second and third steering column switches 6, 7 and 9 when assembled, while the plug pins 63 provide contact between the steering column module and the vehicle.

The casing 45 is provided with plug casings 65 and 67 which receive the plug pins 61 and 63 in the assembled state of the steering angle sensor to obtain complete plug contact. The carrier 25 is provided with a contact plug 69 which provides contact between the signal transmission case 1 and the steering angle sensor 3 when the steering angle sensor 3 is assembled.

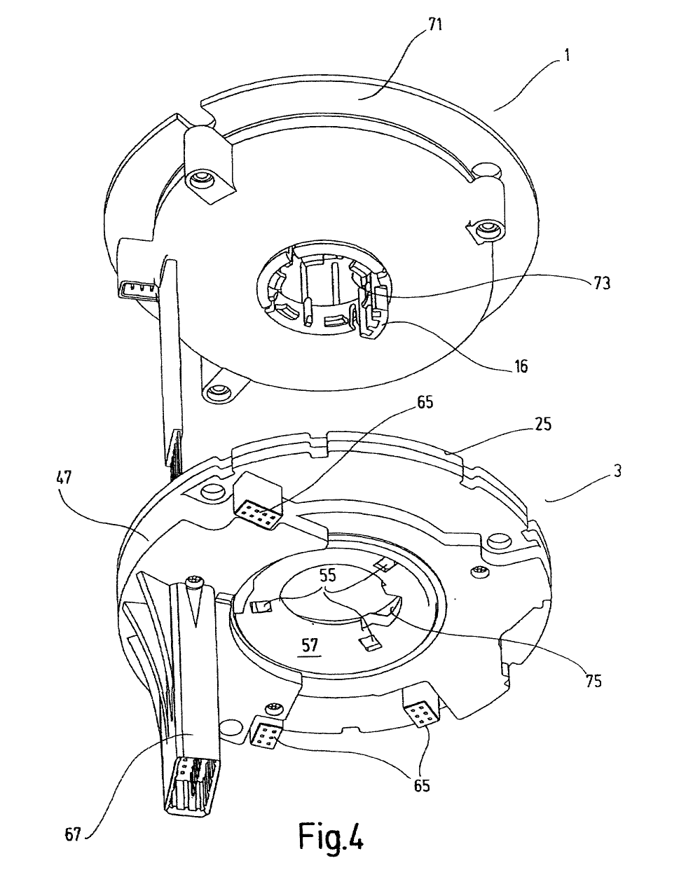

FIG. 4 shows the signal transmission case 1 and the steering angle sensor 3. This representation shows the rotary part 71 of the signal transmission case 1. It is pushed with its bore 73 over the steering column (not shown in FIG. 4) and rotates along therewith. The pin 16 of the rotating part 71 engages in a recess 75 of the bearing piece 57 of the code disc 27 when the signal transmission case 1 is pushed onto the steering angle sensor 3 thereby effecting transmission of the steering motion between the signal transmission case 1 and the steering angle sensor 3, without play. The pin 16 can move in the radial and axial direction relative to the recess 73 of the code disc 27.

FIG. 4 also shows that the plug pins 77 produce the electric connection of the signal transmission case 1 to the steering angle sensor 3 and the vehicle, when assembled.

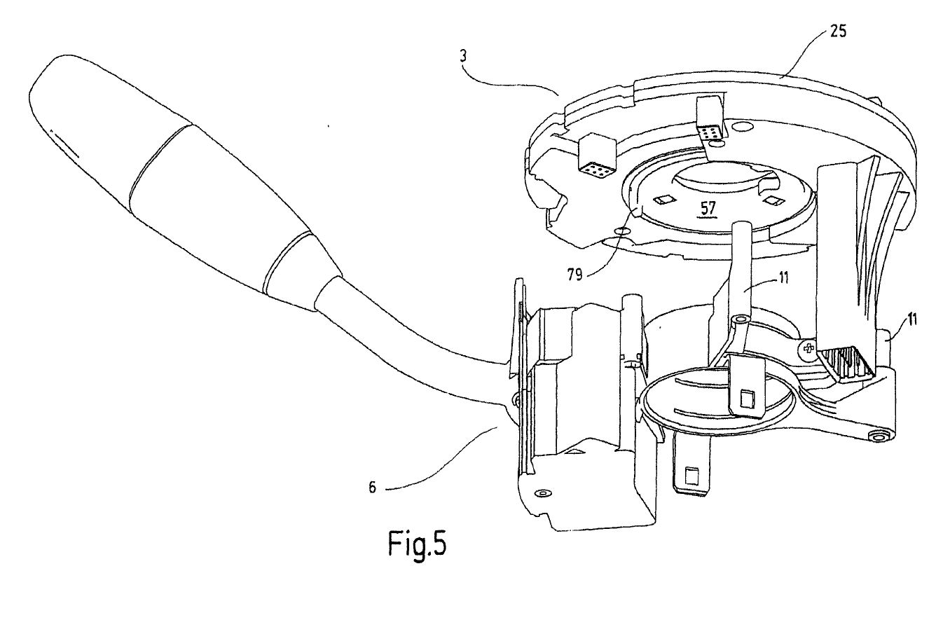

FIG. 5 shows the steering angle sensor 3 and the steering column switch 6 for actuating the blinkers. This figure illustrates the mounting of the code disc 27 in the carrier 25 via bearing ring 49 and bearing piece 57. The bearing piece comprises a pin 79 which projects towards the first steering column switch 6, past the code disc 27 and beyond the steering angle sensor 3. In the assembled state, the pin 79 actuates a restoring cam of the first steering column switch 6 (which is not shown in this representation) thereby restoring the first steering column switch and terminating blinker indication of the vehicle.

All the features shown in the description, in the following claims and in the drawing may be essential to the invention either individually or collectively in any arbitrary combination.

We claim:

1. A steering column module for vehicles having a steering wheel, the module comprising:
a stationary signal transmission case component;
a rotatable signal transmission case component mounted in said stationary component for secure mutual rotation with the steering wheel;
a steering angle sensor for measuring a steering angle of the steering wheel; and
a rotatable code disc borne by said steering angle sensor for secure mutual rotation with the steering wheel.

2. The steering column module of claim 1, wherein said code disc cooperates with said rotatable case component for secure mutual rotation therewith.

3. The steering column module of claim 2, wherein one of said code disc and said rotatable case component comprises at least one projection extending in an axial direction which engages in at least one associated recess, extending in the radial direction, in an other of said rotatable case component and said code disc.

4. The steering column module of claim 3, wherein said at least one projection is a pin which is eccentrically disposed and extends in an axial direction, and wherein said at least one associated recess is a slot extending in a radial direction.

5. The steering column module of claim 1, wherein said steering angle sensor comprises a carrier within which said code disc is radially secured and rotatably disposed.

6. The steering column module of claim 1, wherein said steering angle sensor comprises a casing within which said code disc is radially secured and rotatably disposed.

7. The steering column module of claim 1, wherein said steering angle sensor comprises a bearing piece having a bearing ring in which said code disc is disposed.

8. The steering column module of claim 1, wherein said steering angle sensor comprises a carrier, bearing a scanning device for scanning said code disc.

9. The steering column module of claim 1, wherein said code disc has rotary angle encoding disposed on an end face thereof.

10. The steering column module of claim 1, wherein said code disc has holes constituting rotary angle encoding.

11. The steering column module of claim 1, wherein said code disc has a rotary angle encoding disposed on an outer surface thereof.

12. The steering column module of claim 1, further comprising at least one steering column switch.

13. The steering column module of claim 12, wherein a first steering column switch cooperates in a modular fashion with at least one of said stationary transmission case component, said steering angle sensor, said rotatable transmission case, a second steering column switch, and a third steering column switch.

14. The steering column module of claim 13, wherein at least one of said stationary transmission case component and said rotatable transmission case component has a first evaluation electronics, and wherein said steering angle sensor has a second evaluation electronics disposed in close proximity to said first evaluation electronics.

15. The steering column module of claim 12, wherein a first steering column switch actuates a blinker and has a blinker returning position which can be controlled by said steering angle sensor.
